(19) United States
(12) Patent Application Publication
(10) Pub. No.: US 2011/0103118 A1
(43) Pub. Date: May 5, 2011

(54) NON-ISOLATED DC-DC CONVERTER ASSEMBLY

(75) Inventors: Leonardo-Augusto SERPA, Zurich (CH); Mikko Paakkinen, Espoo (FI); Francisco Canales, Baden-Dattwill (CH); Gerardo Escobar, Zurich (CH); Antonio Coccia, Baden (CH)

(73) Assignee: ABB Research Ltd., Zurich (CH)

(21) Appl. No.: 12/917,879

(22) Filed: Nov. 2, 2010

(30) Foreign Application Priority Data
Nov. 2, 2009 (EP) 09174753.5

(51) Int. Cl. G05F 3/08; H02M 7/5387

(52) U.S. Cl. 363/132; 323/311

(57) ABSTRACT

A non-isolated DC-DC converter assembly includes a boost converter and a Ćuk converter connected together in a specific way. The non-isolated DC-DC converter assembly allows for grounding of a source and load at the same time, and provides a complete adjustability of the output voltage of the non-isolated DC-DC converter. Further, the DC-DC converter assembly of the disclosure has a current source input characteristic, whereby the current absorbed from the power supply is continuous

### RELATED APPLICATION

This application claims priority under 35 U.S.C. §119 to European Patent Application No. 09174753.5 filed in Europe on Nov. 2, 2009, the entire content of which is hereby incorporated by reference in its entirety.

### FIELD

The present disclosure relates to a non-isolated DC-DC converter assembly, such as a non-isolated DC-DC converter assembly which is suitable for use with a photovoltaic cell, for example.

### BACKGROUND

Nowadays, there are generally two main groups of photovoltaic (PV) inverters, namely isolated and non-isolated. Due to the galvanic isolation, the isolated inverters allow the photovoltaic panel terminal to be grounded, which is mandatory in some countries due to safety issues relating to leakage current. Grounding the negative photovoltaic panel terminal is also advantageous because it alleviates degradation problems of the photovoltaic panels. Even in countries where the galvanic isolation is not mandatory, the presence of the transformer is required when some photovoltaic cell technologies, e.g. thin-film, are employed. However, this extra component, e.g., the transformer, when operating at a low frequency, increases the overall volume, weight and cost of the system. In order to overcome that, the low frequency transformer has been replaced by high-frequency transformers operating in an intermediary isolated dc-dc converter. Nevertheless, this alternative generally results in a more complex system configuration as well as additional costs due to the higher number of active and passive devices. Due to these limitations, emphasis has been given to photovoltaic inverters without any kind of transformer, which are called non-isolated PV inverters. This family of converters is able to provide higher efficiency with low size and volume. Also, manufacturing costs may be lower. However, it still has to comply with safety and degradation issues. Therefore, non-isolated PV inverters require a dedicated topology either on the dc-dc converter side or on the inverter side.

A known photovoltaic inverter assembly includes a boost converter connected to a full-bridge inverter. The boost converter boosts the voltage generated by a photovoltaic string to a level which is necessary for the inverter to transfer the power to the grid. However, although the boost converter has advantages, such as a low number of components and simplicity, it has some disadvantages with regard to the connection with the above-mentioned photovoltaic inverter assembly. If the full-bridge inverter operates under a unipolar modulation, which has a higher efficiency as compared to bipolar modulation, a parasitic capacitance existing between the negative terminal of the photovoltaic string and ground creates a path to a common-mode current to circulate. This common-mode current will superimpose the load current causing EMI, safety and degradation problems.

In published patent application U.S. 2004/0164557, entitled “Monopolar DC to Bipolar to AC Converter”, a DC-DC converter is proposed which permits the source and load to be grounded at the same time. The output voltage of the DC-DC converter proposed in U.S. 2004/0164557 cannot be regulated. In operating situations where the voltage generated by the source of the DC-DC converter is below the level requested by the load, the converter has to shutdown, thereby reducing system availability. Further, since the DC-DC converter of U.S. 2004/0164557 includes a buck-boost converter, the source will suffer from a pulsating current.

### SUMMARY

An exemplary embodiment provides a non-isolated DC-DC converter assembly which includes a positive input terminal, a negative input terminal, a positive output terminal, and a negative output terminal. The exemplary DC-DC converter assembly includes a boost converter having a first input terminal, a second input terminal, a first output terminal and a second output terminal. The exemplary DC-DC converter assembly also includes an intermediate output terminal, and a Ćuk converter, which includes a first input terminal, a second input terminal, a first output terminal and a second output terminal. The first input terminal of the boost converter and the second input terminal of the Ćuk converter are conductively connected to the positive input terminal. The second input terminal of the boost converter and the first input terminal of the Ćuk converter are conductively connected to the negative input terminal. The first output terminal of the boost converter is conductively connected to the positive output terminal. The second output terminal of the Ćuk converter is conductively connected to the negative output terminal. The second output terminal of the boost converter and the first output terminal of the Ćuk converter are conductively connected to the intermediate output terminal. The negative input terminal and the intermediate output terminal are configured to be grounded.

### BRIEF DESCRIPTION OF THE DRAWINGS

Additional refinements, advantages and features of the present disclosure are described in more detail below with reference to exemplary embodiments illustrated in the drawings, in which:

FIG. 1 shows a known boost converter;

FIG. 2 shows a known Ćuk converter;

FIG. 3 shows an exemplary embodiment of a non-isolated DC-DC converter assembly connected to a photovoltaic cell, according to an embodiment of the present disclosure; and

FIG. 4 shows a simplified circuit diagram of a solar power station including the exemplary converter assembly of FIG. 3.

### DETAILED DESCRIPTION

Exemplary embodiments of the present disclosure provide a non-isolated dc-dc converter which allows grounding the negative terminal of the photovoltaic modules, avoiding any safety or degradation issue caused by leakage current flowing in existing parasitic capacitors.

According to an exemplary embodiment, the non-isolated DC-DC converter assembly includes a boost converter and a Ćuk converter connected together in a specific way.

According to an exemplary embodiment, the non-isolated DC-DC converter assembly allows for grounding of a source and load at the same time. In accordance with exemplary embodiments of the present disclosure, a complete adjustability of the output voltage of the non-isolated DC-DC converter is achieved. Further, the DC-DC converter assembly of the disclosure has current source input characteristic, whereby the current absorbed from the power supply is continuous.

The converter assembly according to exemplary embodiments of the present disclosure can be installed using any kind of photovoltaic cell technologies without of the drawback of low efficiency, large volume and high cost associated with isolated photovoltaic converters. The possibility of grounding the power supply and the load at the same time allows removing the bulky transformer while still avoiding any EMI aspects caused by the presence of a common-mode current flowing through parasitic components.

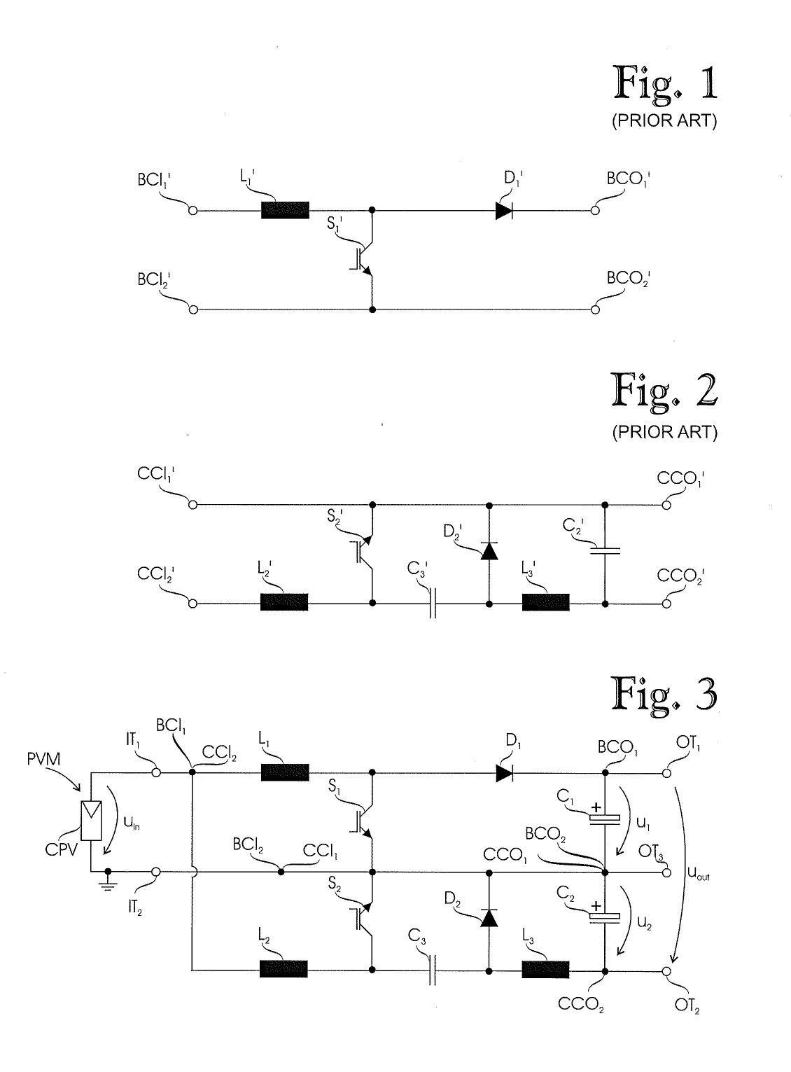

FIG. 1 shows a conventional boost converter configured to step up input voltage into higher output voltage. The boost converter includes an inductor L₁′, a diode D₁′ and a controllable switch S₁′. The boost converter has a first input terminal BCI₁′, a second input terminal BCI₂′, a first output terminal BCO₁′ and a second output terminal BCO₂′. The input direct voltage is inputted through the first input terminal BCI₁′ and the second input terminal BCI₂′. The first input terminal BCI₁′ is a positive terminal, and the second input terminal BCI₂′ is a negative terminal. The output voltage is present between the first output terminal BCO₁′ and the second output terminal BCO₂′. The first output terminal BCO₁′ is a positive terminal, and the second output terminal BCO₂′ is a negative terminal.

The inductor L₁′ and the diode D₁′ are connected in series between the first input terminal BCI₁′ of the boost converter and the first output terminal BCO₁′ of the boost converter. The cathode of the diode D₁′ is connected to the first output terminal BCO₁′. The collector of the controllable switch S₁′ is connected between the inductor L₁′ and the anode of the diode D₁′, and the emitter of the controllable switch S₁′ is connected between the second input terminal BCI₂′ and the second output terminal BCO₂′. The second input terminal BCI₂′ and the second output terminal BCO₂′ are connected with a conductor having neither active nor passive components. Therefore, the second input terminal BCI₂′ and the second output terminal BCO₂′ are, in operating conditions, substantially at the same electric potential.

FIG. 2 shows a known Ćuk converter. The Ćuk converter is capable of stepping up and stepping down its input voltage. The Ćuk converter includes inductors L₂′ and L₃′, a diode D₂′, a controllable switch S₂′, and capacitors C₂′ and C₃′. The Ćuk converter has a first input terminal CCI₁′, a second input terminal CCI₂′, a first output terminal CCO₁′ and a second output terminal CCO₂′. The input direct voltage is inputted through the first input terminal CCI₁′ and the second input terminal CCI₂′. The output voltage is present between the first output terminal CCO₁′ and the second output terminal CCO₂′.

The Ćuk converter of FIG. 2 is an inverting converter, which means that the output voltage is negative with respect to the input voltage. This means that if an operator wants the first output terminal CCO₁′ of the Ćuk converter to be the positive one, then the second input terminal CCI₂′ must be connected to a higher electrical potential than the first input terminal CCI₁′ of the Ćuk converter.

The inductor L₂′, the capacitor C₃′ and the inductor L₃′ are connected in series between the second input terminal CCI₂′ of the Ćuk converter and the second output terminal CCO₂′ of the Ćuk converter such that the capacitor C₃′ is located electrically between the inductor L₂′ and the inductor L₃′. The inductor L₂′ is connected between the second input terminal CCI₂′ and the capacitor C₃′, and the inductor L₃′ is connected between the second output terminal CCO₂′ and the capacitor C₃′.

A collector of the controllable switch S₂′ is connected between the inductor L₂′ and the capacitor C₃′, and the emitter of the controllable switch S₂′ is connected between the first input terminal CCI₁′ and the first output terminal CCO₁′. The first input terminal CCI₁′ and the first output terminal CCO₁′ of the Ćuk converter are connected with a conductor having neither active nor passive components. Therefore, the first input terminal CCI₁′ and the first output terminal CCO₁′ are, in operating conditions, substantially at the same electric potential.

The anode of the diode D₂′ is connected between the capacitor C₃′ and the inductor L₃′. The cathode of the diode D₂′ is connected between the first input terminal CCI₁′ and the first output terminal CCO₁′.

The capacitor C₂′ is connected between the first output terminal CCO₁′ and the second output terminal CCO₂′. Therefore the voltage of the capacitor C₂′ is equal to the output voltage of the Ćuk converter.

FIG. 3 shows a non-isolated DC-DC converter assembly according to an exemplary embodiment of the present disclosure connected to a photovoltaic cell means (PVM) having a photovoltaic cell CPV. The photovoltaic cell CPV is configured to convert solar energy into direct current (DC). The photovoltaic cell CPV is configured to generate a direct voltage uᵢₙ, which is the input voltage of the non-isolated DC-DC converter assembly. The photovoltaic cell CPV can be based on any known photovoltaic cell technology.

The converter assembly according to exemplary embodiments of the present disclosure includes features of the boost converter shown in FIG. 1 and the Ćuk converter shown in FIG. 2. For example, according to an exemplary embodiment depicted in FIG. 3, the converter assembly is a combination of the boost converter shown in FIG. 1 and the Ćuk converter shown in FIG. 2. The converter assembly has a positive input terminal IT₁, a negative input terminal IT₂, a positive output terminal OT₁ and a negative output terminal OT₂. The input voltage of the converter assembly is present between the positive input terminal IT₁ and the negative input terminal IT₂. The boost converter and the Ćuk converter are connected such that the output voltage uₒᵤₜ of the converter assembly present between the positive output terminal OT₁ and the negative output terminal OT₂ is substantially a sum of the absolute values of output voltages of the boost converter and the Ćuk converter.

According to an exemplary embodiment, the non-isolated DC-DC converter assembly of FIG. 3 includes all the components in the boost converter of FIG. 1 and in the Ćuk converter of FIG. 2. Reference signs used in FIG. 3 correspond to those used in FIGS. 1 and 2 with the exception that apostrophes (') have been removed.

The boost converter of FIG. 3 has a first input terminal BCI₁, a second input terminal BCI₂, a first output terminal BCO₁ and a second output terminal BCO₂. The output voltage u₁ of the boost converter is present between the first output terminal BCO₁ and the second output terminal BCO₂. The Ćuk converter of FIG. 3 has a first input terminal CCI₁, a second input terminal CCI₂, a first output terminal CCO₁ and a second output terminal CCO₂. The output voltage u₂ of the Ćuk converter is present between the first output terminal CCO₁ and the second output terminal CCO₂. The output voltage uₒᵤₜ of the non-isolated DC-DC converter assembly of FIG. 3 is a sum of the output voltage u₁ of the boost converter and the output voltage u₂ of the Ćuk converter.

The first input terminal BCI₁ of the boost converter and the second input terminal CCI₂ of the Ćuk converter are conductively connected to the positive input terminal IT₁ such that, in operating situations, the first input terminal BCI₁, the second input terminal CCI₂, and the positive input terminal are at the same electric potential. The second input terminal BCI₂ of the boost converter and the first input terminal CCI₁ of the Ćuk converter are conductively connected to the negative input terminal IT₂ such that, in operating situations, the second input terminal BCI₂, the first input terminal CCI₁, and the negative input terminal IT₂ are at the same electric potential. The first output terminal BCO₁ of the boost converter is conductively connected to the positive output terminal OT₁ such that, in operating situations, the first output terminal BCO₁ and the positive output terminal OT₁ are at the same electric potential. The second output terminal CCO₂ of the Ćuk converter is conductively connected to the negative output terminal OT₂ such that, in operating situations, the second output terminal CCO₂ and the negative output terminal OT₂ are at the same electric potential.

The converter assembly of FIG. 3 has an intermediate output terminal OT₃, which is conductively connected to the second output terminal BCO₂ of the boost converter and the first output terminal CCO₁ of the Ćuk converter. Since there are neither active nor passive components between the intermediate output terminal OT₃ and the negative input terminal IT₂, these two terminals are, in operating situations, at the same electric potential.

The boost converter of FIG. 3 includes a first inductor L₁, a first diode D₁, a first controllable switch S₁ and a first capacitor C₁. The first inductor L₁ and the first diode D₁ are connected in series between the first input terminal BCI₁ of the boost converter and the first output terminal BCO₁ of the boost converter. The cathode of the first diode D₁ is connected to the first output terminal BCO₁ of the boost converter. The first controllable switch S₁ is located electrically between a point situated electrically between the first inductor L₁ and the first diode D₁, and a point situated electrically between the second input terminal BCI₂ of the boost converter and the second output terminal BCO₂ of the boost converter. The collector of the first controllable switch S₁ is connected between the first inductor L₁ and the anode of the first diode D₁. The first capacitor C₁ is connected between the first output terminal BCO₁ of the boost converter and the second output terminal BCO₂ of the boost converter.

It is to be noted that in the boost converter of FIG. 1 there is no first capacitor C₁ or any equivalent component. There are no further additional components in the converter assembly of FIG. 3. All other components of the converter assembly of FIG. 3 are present in the boost converter of FIG. 1 and in the Ćuk converter of FIG. 2.

The Ćuk converter of FIG. 3 includes a second inductor L₂, a third inductor L₃, a second diode D₂, a second controllable switch S₂, a second capacitor C₂ and a third capacitor C₃. The second inductor L₂, the third capacitor C₃ and the third inductor L₃ are connected in series between the second input terminal CCI₂ of the Ćuk converter and the second output terminal CCO₂ of the Ćuk converter such that the third capacitor C₃ is located electrically between the second inductor L₂ and the third inductor L₃. The second controllable switch S₂ is located electrically between a point situated electrically between the second inductor L₂ and the third capacitor C₃, and a point situated electrically between the first input terminal CCI₁ of the Ćuk converter and the first output terminal CCO₁ of the Ćuk converter. The collector of the second controllable switch S₂ is connected between the second inductor L₂ and the third capacitor C₃. The second diode D₂ is located electrically between a point situated electrically between the third capacitor C₃ and the third inductor L₃, and a point situated electrically between the first input terminal CCI₁ of the Ćuk converter and the first output terminal CCO₁ of the Ćuk converter. The anode of the second diode D₂ is connected between the third capacitor C₃ and the third inductor L₃. The cathode of the second diode D₂ is connected between the first input terminal CCI₁ and the first output terminal CCO₁. The second capacitor C₂ is located electrically between the first output terminal CCO₁ of the Ćuk converter and the second output terminal CCO₂ of the Ćuk converter.

The negative input terminal IT₂ is grounded. Therefore, the second output terminal BCO₂ of the boost converter, the first output terminal CCO₁ of the Ćuk converter, and the intermediate output terminal OT₃ are also grounded. Further, a point between the emitter of the first controllable switch S₁ and the emitter of the second controllable switch S₂ is grounded, a point between series-connected first capacitor C₁ and second capacitor C₂ is grounded, and a cathode of the second diode D₂ is grounded.

As mentioned above, the output voltage uₒᵤₜ is a sum of the output voltage u₁ of the boost converter and the output voltage u₂ of the Ćuk converter. Voltages u₁ and u₂ may be regulated independently according to equations {1} and {2} below. Voltage u₁ can be controlled by adjusting the duty-cycle DS₁ of switch S₁ according to equation {1}. The duty-cycle DS₂ of switch S₂ can be controlled according to equation {2} in order to regulate voltage u₂.

$$\begin{matrix}{u}_{1} = \frac{1}{1 - {DS}_{1}} \cdot {u}_{i n} & \{ 1 \} \\ {u}_{2} = \frac{{DS}_{2}}{1 - {DS}_{2}} \cdot {u}_{i n} & \{ 2 \}\end{matrix}$$

The non-isolated DC-DC converter assembly of FIG. 3 has a current source input characteristic, whereby the current absorbed from the power supply, such as the photovoltaic cell means PVM, is continuous. A ripple peakto-peak value of the current absorbed from the photovoltaic cell means PVM is dependent on the inductances of the first inductor L₁ and second inductor L₂.

In the exemplary embodiments discussed above, the first controllable switch S₁ and the second controllable switch S₂ are IGBTs (Insulated Gate Bipolar Transistors), but one skilled in the art would understand that other types of controllable switches may also be used as the first controllable switch S₁ and the second controllable switch S₂.

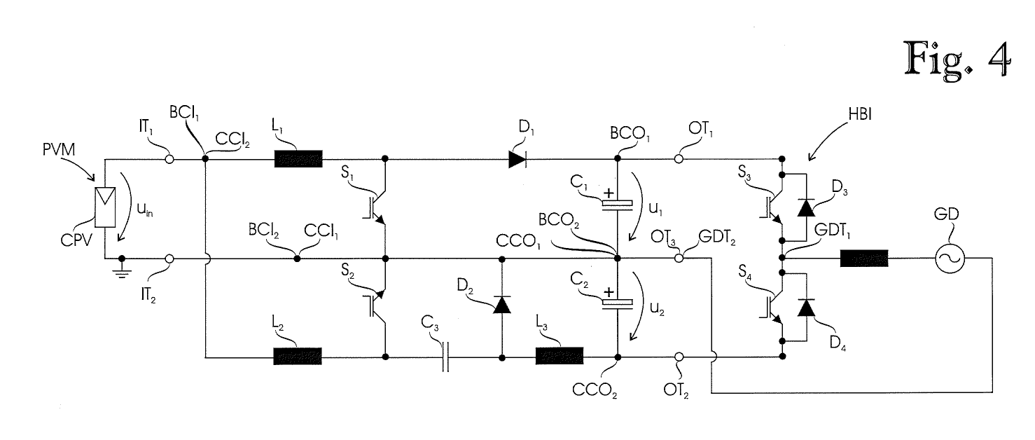

FIG. 4 shows a simplified circuit diagram of a solar power station including photovoltaic cell means PVM, the non-isolated DC-DC converter assembly of FIG. 3, and a half-bridge inverter HBI. The connection between the photovoltaic cell means PVM and the non-isolated DC-DC converter assembly is identical to the connection in FIG. 3. The half-bridge inverter HBI connected to the DC-DC converter assembly can be a known two-level half-bridge inverter, for example. The half-bridge inverter HBI is connected to an electrical power network GD. The half-bridge inverter HBI includes a third controllable switch S₃, a third diode D₃, a fourth controllable switch S₄, and a fourth diode D₄. The third controllable switch S₃ and the fourth controllable switch S₄ are connected in series between the positive output terminal OT₁ and the negative output terminal OT₂. The third diode D₃ is connected anti-parallel with the third controllable switch S₃. The fourth diode D₄ is connected anti-parallel with the fourth controllable switch S₄.

The electrical power network GD has a first grid terminal GDT₁ and a second grid terminal GDT₂. The first grid terminal GDT₁ is connected between the emitter of the third controllable switch S₃ and the collector of the fourth controllable switch S₄. The second grid terminal GDT₂ is connected to the intermediate output terminal OT₃. The negative input terminal IT2 and the intermediate output terminal OT₃ are connected with a conductor having neither active nor passive components. Therefore, in operating conditions, the second grid terminal GDT₂ and the negative input terminal IT2 are at the same electric potential. Consequently, the second grid terminal GDT₂ is earthed via the ground connection adjacent the negative terminal of the photovoltaic cell CPV.

Herein, the expression “solar power station” is to be interpreted broadly. The expression is not limited to systems adapted to capture energy exclusively from sunlight. Instead, the light or other energy may originate, for example, from some industrial process or from any other source. Further, the nominal power of the solar power station is not limited in any way. Therefore, a solar power station may be a device capable of generating couple of watts or a huge scale power plant having nominal output of several gigawatts.

In the circuit diagram of FIG. 4, the electrical power network GD represents the load of the half-bridge inverter HBI, and therefore also the load of the entire inverter assembly including the non-isolated DC-DC converter assembly and the half-bridge inverter HBI. One skilled in the art would understand that it is possible to connect a variety of different loads to the half bridge inverter.

In accordance with another exemplary embodiment, a DC-DC converter assembly may be connected to an electrical power network by another type of half-bride inverter instead of a two-level half-bridge inverter. The DC-DC converter assembly may be connected to the grid by a known half-bridge three-level NPC inverter, for example. It is also possible to use a higher level half-bridge inverter such as a five-level half-bridge inverter, for example.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A non-isolated DC-DC converter assembly comprising:
a positive input terminal;
a negative input terminal;
a positive output terminal;
a negative output terminal;
a boost converter including a first input terminal, a second input terminal, a first output terminal and a second output terminal;
an intermediate output terminal; and
a Ćuk converter including a first input terminal, a second input terminal, a first output terminal and a second output terminal, wherein:
the first input terminal of the boost converter and the second input terminal of the Ćuk converter are conductively connected to the positive input terminal;
the second input terminal of the boost converter and the first input terminal of the Ćuk converter are conductively connected to the negative input terminal;
the first output terminal of the boost converter is conductively connected to the positive output terminal;
the second output terminal of the Ćuk converter is conductively connected to the negative output terminal;
the second output terminal of the boost converter and the first output terminal of the Ćuk converter are conductively connected to the intermediate output terminal; and
the negative input terminal and the intermediate output terminal are configured to be grounded.

2. A converter assembly according to claim 1, wherein the negative input terminal and the intermediate output terminal are conductively connected to each other.

3. A converter assembly according to claim 1, wherein:
the boost converter comprises a first inductor, a first diode, a first controllable switch and a first capacitor;
the first inductor and the first diode is connected in series between the first input terminal of the boost converter and the first output terminal of the boost converter;
the first controllable switch is located electrically between a point situated electrically between the first inductor and the first diode, and a point situated electrically between the second input terminal of the boost converter and the second output terminal of the boost converter; and
the first capacitor is located electrically between the first output terminal of the boost converter and the second output terminal of the boost converter.

4. A converter assembly according to claim 1, wherein:
the Ćuk converter comprises a second inductor, a third inductor, a second diode, a second controllable switch, a second capacitor and a third capacitor;
the second inductor, the third capacitor and the third inductor are connected in series between the second input terminal of the Ćuk converter and the second output terminal of the Ćuk converter such that the third capacitor is located electrically between the second inductor and the third inductor;
the second controllable switch is located electrically between a point situated electrically between the second inductor and the third capacitor, and a point situated electrically between the first input terminal of the Ćuk converter and the first output terminal of the Ćuk converter;
the second diode is located electrically between a point situated electrically between the third capacitor and the third inductor, and a point situated electrically between the first input terminal of the Ćuk converter and the first output terminal of the Ćuk converter; and
the second capacitor is located electrically between the first output terminal of the Ćuk converter and the second output terminal of the Ćuk converter.

6. A solar power station comprising:
photovoltaic cell means having at least one photovoltaic cell configured to convert solar energy into direct current; and
the converter assembly according to claim 1,
wherein the at least one photovoltaic cell is connected between the positive input terminal and the negative input terminal of the converter assembly.

7. An inverter assembly comprising:
a half-bridge inverter; and
the non-isolated DC-DC converter assembly as claimed in claim 1,
wherein the half-bridge inverter is connected between the positive output terminal and the negative output terminal, and the intermediate output terminal is configured to be connected to a load of the half-bridge inverter.

8. A converter assembly according to claim 2, wherein:
the boost converter comprises a first inductor, a first diode, a first controllable switch and a first capacitor;
the first inductor and the first diode are connected in series between the first input terminal of the boost converter and the first output terminal of the boost converter;
the first controllable switch is located electrically between a point situated electrically between the first inductor and the first diode, and a point situated electrically between the second input terminal of the boost converter and the second output terminal of the boost converter; and
the first capacitor is located electrically between the first output terminal of the boost converter and the second output terminal of the boost converter.

9. A converter assembly according to claim 3, wherein:
the Ćuk converter comprises a second inductor, a third inductor, a second diode, a second controllable switch, a second capacitor and a third capacitor;
the second inductor, the third capacitor and the third inductor are connected in series between the second input terminal of the Ćuk converter and the second output terminal of the Ćuk converter such that the third capacitor is located electrically between the second inductor and the third inductor;
the second controllable switch is located electrically between a point situated electrically between the second inductor and the third capacitor, and a point situated electrically between the first input terminal of the Ćuk converter and the first output terminal of the Ćuk converter;
the second diode is located electrically between a point situated electrically between the third capacitor and the third inductor, and a point situated electrically between the first input terminal of the Ćuk converter and the first output terminal of the Ćuk converter; and
the second capacitor is located electrically between the first output terminal of the Ćuk converter and the second output terminal of the Ćuk converter.

10. A converter assembly according to claim 9, wherein a point between the emitter of the first controllable switch and the emitter of the second controllable switch, a point between series-connected first capacitor and second capacitor, and a cathode of the second diode are, in operating situations substantially at the same electric potential as the negative input terminal.
